(19) United States
(12) Patent Application Publication
(10) Pub. No.: US 2019/0171657 A1
(43) Pub. Date: Jun. 6, 2019

(54) GEOSPATIAL MAPPING SYSTEM

(71) Applicant: QUEENSLAND ELECTRICITY TRANSMISSION CORPORATION, Virginia (AU)

(72) Inventors: Aaron Ambler, Virginia (AU); Sharna Bourke, Virginia (AU); Brendan Soustal, Virginia (AU); Ronald Innis, Virginia (AU); Steve Cyphers, Virginia (AU)

(21) Appl. No.: 16/321,818

(22) PCT Filed: Jun. 21, 2017
(86) PCT No.: PCT/AU2017/050624

§ 371 Date: Jan. 29, 2019

(30) Foreign Application Priority Data
Jul. 29, 2016 (AU) 2016902991

(51) Int. Cl. G06F 16/29; G06F 16/44

(52) U.S. Cl. CPC G06F 16/29; G06F 16/444

(57) ABSTRACT

A geospatial mapping system and method is provided, including: at least one data store, including: geospatial mapping data including a plurality of different types of data and relating to a plurality of geographical areas; a plurality of map product definitions, each map product definition relating a map product to at least one type of geospatial mapping data of the geospatial mapping data; and a mapping server, coupled to the at least one data store. The mapping server is configured to receive a selection of an area and a map product; and generate a map according to the selected area and map product, and the map product definitions.

### TECHNICAL FIELD

The present invention relates to geospatial mapping. In particular, the present invention relates to automatic map generation.

### BACKGROUND ART

Maps are a very efficient way of visualising spatial data, and geospatial mapping systems have simplified the process of creating such maps, by enabling spatial data to be overlaid on maps.

Geospatial mapping systems are popular in planning environments, as they enable the user to visualise geographic information relative to a map. This in turn improves decision making abilities, as patterns and elements of the data may be far more apparent when present on a map, than if the spatial data is considered separately.

A problem, however, with geospatial mapping systems of the prior art is that they are complex and time consuming. It is not uncommon for a map product to take several hours or days to be generated, as data is overlaid manually by a geographic information systems (GIS) expert. Furthermore, as the maps are generated manually, they are prone to human error, and are often inconsistent.

As such, there is clearly a need for an improved geospatial mapping system.

It will be clearly understood that, if a prior art publication is referred to herein, this reference does not constitute an admission that the publication forms part of the common general knowledge in the art in Australia or in any other country.

### SUMMARY OF INVENTION

The present invention is directed to geospatial mapping systems and methods, which may at least partially overcome at least one of the abovementioned disadvantages or provide the consumer with a useful or commercial choice.

With the foregoing in view, the present invention in one form, resides broadly in a geospatial mapping system including:
at least one data store, including:
   geospatial mapping data including a plurality of different types of data and relating to a plurality of geographical areas;
   a plurality of map product definitions, each map product definition relating a map product to at least one type of geospatial mapping data of the geospatial mapping data; and
   a mapping server, coupled to the at least one data store, configured to: receive a selection of an area and a map product; and
   generate a map according to the selected area and map product, and the map product definitions.

Advantageously, the geospatial mapping system enables maps to be automatically generated according to map product and area selections by a user. This simplifies the process of creating maps significantly, and can provide improved quality and consistency across maps.

Preferably, the selection of the area and the map product is provided by a user, and the generated map is provided to the user in response thereto. In some embodiments, the map is provided to the user by electronic mail.

Preferably, the selected map product is associated with more than one type of geospatial mapping data, wherein each type of geospatial mapping data is used to generate a different layer of the map.

Preferably, the map is generated according to a style or layout associated with the selected map product. The style may include style elements such as map colour and transparency data. The layout may include marginalia, such as a legend, legal statement, company logos, scale, north arrow and the like.

Preferably, the mapping server is configured to receive one or more map preferences, and generate the map at least in part according to the map preferences. The map preferences may be received from a user. The map preferences may include a map size (e.g. A3) and a map orientation (e.g. landscape).

Preferably, the mapping server is configured to receive a request to generate a map or a plurality of maps forming a map book. Each map may relate to part of the selected area, such that the plurality of maps together relate to the selected area. The map book may include an overview map, illustrating the relative position of each of the plurality of maps.

Suitably, the different mapping products relate to different types of mapping data. For example, a first mapping product may be associated with a high quality satellite image, whereas a second mapping product may be associated with vector graphic representations of objects.

Suitably, the different mapping products relate to different layouts or styles. As such, the user is able to generate maps of select different layouts or styles through selection of the mapping product.

Preferably, the plurality of different types of data include power transmission related data, such as power station data, transmission tower data, and transmission line data.

Preferably, the plurality of different types of data include land ownership data and/or land rights data.

Preferably, the system includes a look-up table, for associating map products with data types.

Preferably, the mapping server is configured to retrieve geospatial mapping data, from the data store, according to the selected area and the map product. Suitably, the geospatial mapping data is received using one or more Procedural Language/Structured Query Language (PL/SQL) queries.

Preferably, the system is configured to filter the retrieved data according to the selected area. Suitably, the system is configured to filter one or more data types such that only data relating to the selected area is shown. This is particularly advantageous when the map does not correspond exactly to the selected area.

Suitably, the different types of data relate to different types of objects, such as transmission towers, power stations and the like.

Suitably, the different types of data relate to different types of measurements or data estimates, such as population density.

Suitably, the selected area may be defined by a lot, a region, a project, a site, a corridor, a plan, a feature, a maintenance region, and a feeder network.

In another form, the method resides in a geospatial mapping method including: receiving, from a user, a selection of an area and a map product; and
generating a map according to the selected area and map product, and a map product definition associated with the selected map product, wherein
the map product definition relates the associated map product to at least one type of geospatial mapping data of a plurality of types of mapping data, and the map includes the mapping data.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a schematic of a geospatial mapping system, according to an embodiment of the present invention;

FIG. 2 illustrates a screenshot of a data entry screen of the system of FIG. 1, according to an embodiment of the present invention;

FIG. 3 illustrates a screenshot of a first map output of the system of FIG. 1, according to an embodiment of the present invention.

FIG. 4 illustrates a screenshot of a second map output of the system of FIG. 1, according to an embodiment of the present invention.

FIG. 5 illustrates a screenshot of a third map output of the system of FIG. 1, according to an embodiment of the present invention.

FIG. 6 illustrates a geospatial mapping method, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

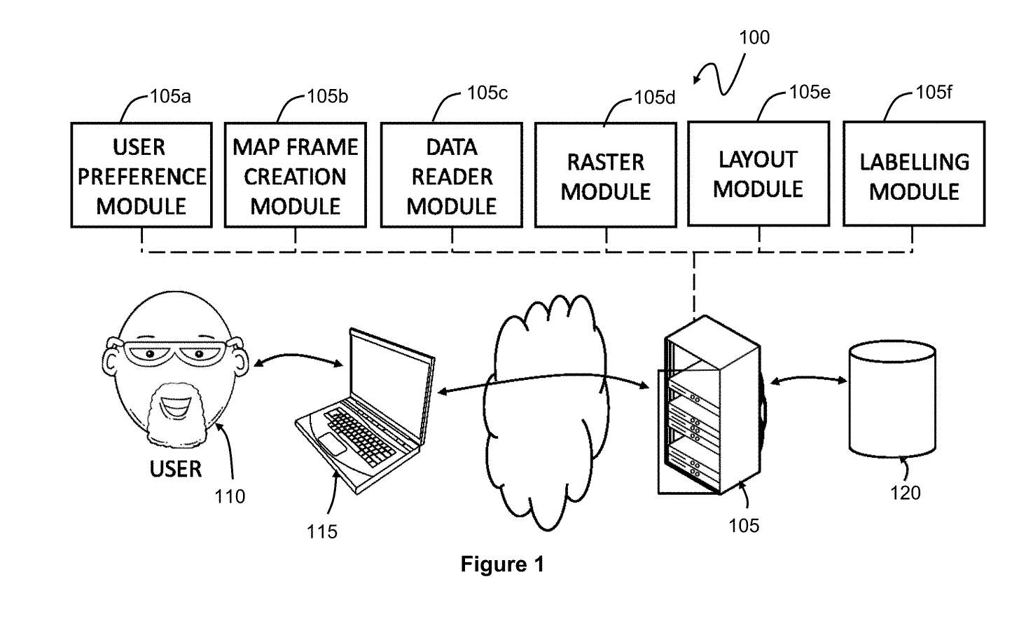

FIG. 1 illustrates a schematic of a geospatial mapping system 100, according to an embodiment of the present invention. The geospatial mapping system 100 enables maps to be automatically generated according to according to area and map product selections, which is an easy to understand and efficient way of generating maps.

The maps can be used for any use case that is defined by an organisations product catalogue. For example, for an electricity company they may be used in relation to planning of new electricity transmission lines. In such case, the output of the system 100 may comprise a map showing the location of proposed transmission towers, electricity lines and easements and properties over which the proposed transmission line route will traverse.

Advantageously, the system 100 reduces the time required to produce maps, is automated and user-friendly, and provides improved quality and consistency across maps. In the past, such maps were manually generated by GIS experts, which was a very time consuming process, and also prone to error. The system 100 enables automated generation of such maps, which significantly reduces the amount of user input required and reduces variability across maps of the same type.

The geospatial mapping system 100 includes a mapping engine 105, with which a user 110 interacts using a computing device 115. In particular, the engine 105 provides a user interface to the computing device 115, in which the user 110 enters details of the required mapping product. A map is then generated by the engine 105 and returned to the user 110 according to the mapping product.

The user interface may be provided to the user in the form of a webpage, where the engine 105 acts as a webserver, as a standalone application run on the computing device 115, or as part of an existing system or systems with which the computing device 115 and engine 105 interact.

As illustrated below, the user interface is simple, and is adapted to be used by users that require maps, rather than GIS experts. The user simply selects a desired mapping product, an area of interest, together with map preferences, and the map is automatically generated. All tasks that previously required the use of a GIS expert are now automated, which enables business managers, decision makers and others that directly use maps to generate them also.

The engine 105 includes a user preference module 105a, which is configured to receive a mapping product selection from the user 110, together with details of an area of interest and user preferences. The user preference module 105a then uses a look-up table, which may be stored on a database 120, coupled to the engine 105, to link the mapping product selection (i.e. the choice of the user 110) to associated parameters and data types, such that the appropriate data can be retrieved in response thereto.

In particular, all mapping products are associated with labelling and style parameters, which are stored in the look up table. This enables requirements relating to the maps, such as mapping standards and policies, including the ability to incorporate logos, disclaimers and other standard text to be incorporated in maps generated by the system, without having to rely on anyone to manually include such features to the map.

Furthermore, different types of data are associated with different mapping products. As an illustrative example, a first mapping product may include satellite image overlays, whereas a second mapping product may instead include vector graphic overlays. The look up table includes a plurality of entries, each relating to a potential layer, and each associated with at least one mapping product. As such, different mapping products are used to generate maps having different types of data overlaid thereon.

As an illustrative example, if the user selects a route plan mapping product, the server 105 will use the look up table to determine which types of mapping data are associated with the route plan mapping product. If ten (10) such entries are provided in the table, ten (10) layers of data are identified to be provided as layers on the map.

The data types/layers may be associated with products using mapping product fields. This enables each layer to be associated with one, or with more than one mapping product. This is particularly advantageous as some data types/layers will be commonly used in map products, whereas others may be niche data types, used in only a few map products.

Furthermore, each mapping product may have a styling entry, defining particular requirements associated with the product. For example, a mapping product for internal use may include internal project identifiers, whereas a mapping product for external publications may be required to comply with a company branding policy.

In short, the system 100 enables the simply creation of a map product, and eliminates the need for the GIS expert to open a workspace and manually select the datasets and styling required for a map. This significantly improves efficiency and reduces the costs associated with developing maps.

The user 110 also selects a region of interest, in relation to which the map shall be generated. The region of interest may comprise a plot of land, a region, a particular project, a site or the like. The region of interest defines the region in which the generated map relates.

Furthermore, the user selects a map book type and a page size and orientation according to the type of map to be generated. The mapbook type may be a single map type (T1/2), or a sequence of maps (T3), and the size and orientation relates to the size and orientation of the map (or each of the maps), such as A3 landscape.

The engine 105 further includes a map frame creation module 105b, which creates a map frame for the region of interest based on the selected mapbook type, page size and orientation, and draws either a best fit or fixed scale frame. In addition to creating the frame geometry, the map frame creation module 105b also determines pdf attributes, for display on the pdf.

The engine 105 includes a data reader module 105c, which is configured to required data based on the product selection, styles the data according to cartographic standards, and returns data that is within the bounds of the map frames. This may be achieved using one or more Procedural Language/Structured Query Language (PL/SQL) queries on the database 120 to retrieve the required data based upon spatial queries.

The data reader module 105c enables data to be retrieved on demand, which in turn enables real time updates to spatial data to be incorporated into generated maps as they are read. Accordingly, maps may represent a real time (or near real time) reflection of the database 120, and may be updated without requiring any coding. Furthermore, maps may be generated periodically and automatically according to data in the database 120. As such, new maps may be continuously provided based upon updates to the data.

The engine 105 includes a raster module 105d, which is configured to extract raster data for a bounding box of a frame and return it as a Joint Photographic Experts Group (JPEG) or Portable Network Graphics (PNG) image file. This module 105d may leverage web serviced data from both internal and external sources, and may access Web Mapping Services (WMS) feeds.

The engine 105 includes a layout module 105e, which is configured to create all static and dynamic layout marginalia of the map. Specifically, the layout module 105e comprises a legend component, a scale bar component and a layout component.

The legend component is configured to create a dynamic legend on the map, which is updated based on the content of the map frame. The scale bar component is similarly configured to create a dynamic scale bar on the map, which is updated based on the content of the map frame, and in particular the map frame scale (MFS) value of the map frame.

The layout component is configured to create the actual layout marginalia for the map. This includes the layout boxes, a tile block and a north arrow. The layout component may also add images, text and the like to comply with styling requirements associated with the selected mapping product.

The engine 105 includes a labelling module 105f, which is configured to dynamically create required labels for the selected product. Specifically, labelling requirements are defined in a look-up table stored in the database 120, which links mapping product selections (i.e. the choice of the user 110) with associated labelling parameters. These parameters are used by the labelling module to create map labels.

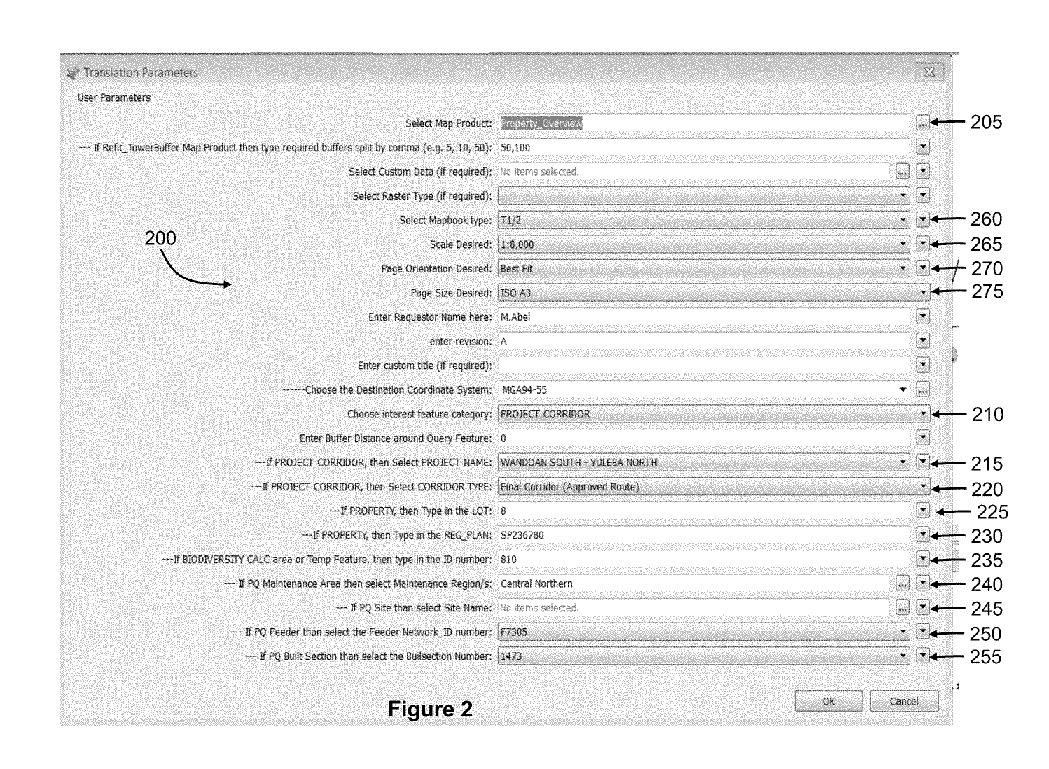

FIG. 2 illustrates a screenshot 200 of an exemplary data entry screen of the system 100, according to an embodiment of the present invention. The data entry screen enables the user 110 to enter details of the type of map product he or she wishes to produce, as well as the area of interest and preferences. The skilled addressee will readily appreciate that the data entry screen will be adapted to suit the types of user choices that drive the engine.

The data entry screen includes a map product entry element 205, which enables the user to enter the desired map product. Examples of map products include a “Property Overview”, and the map product entry element 205 may be associated with a search function, enabling the user 110 to search among available map products.

The data entry screen includes a plurality of feature of interest entry elements 210-270, including an interest feature category selection menu 210, a project name menu 215, a corridor type menu 220, a lot entry field 225, a reg plan entry field 230, a feature ID field 235, a maintenance region field 240, a site name field 245, a feeder network ID field 250, and a built section number field 255.

The data entry screen may be configured to only show relevant entry elements based on prior user selection. For example, if a user selects an interest feature category (using menu 210) then only entry element 225 and 230 may appear, with the remaining selections that are not relevant being removed.

Depending on the type of interest feature category selected in the interest feature category selection menu 210, the user 110 may enter identifying details into one or more of the elements 215-255. For example, if the type of interest feature is selected as being a “project corridor”, the feature of interest may be identified using the project name menu 215 and the corridor selection menu 220.

Similarly, if the type of interest feature is selected as being a “property”, the area of interest may be identified using the lot entry field 225 and the reg plan entry field 230, and if the type of interest feature is selected as being a “biodiversity” or “temporary” area, the area of interest may be identified using the feature ID field 235.

Furthermore, if the type of interest feature is selected as being a PQ maintenance area, the area of interest may be identified using the maintenance region field 240, if the type of interest feature is selected as being a PQ site, the area of interest may be identified using the site name field 245, if the type of interest feature is selected as being PQ feeder, the area of interest may be identified using the feeder network ID field 250, and if the type of interest feature is selected as being a PQ built section, the area of interest may be identified using the built section number field 255.

The data entry screen includes a plurality of layout elements 260-275, including a mapbook type menu 260, a scale menu 265, a page orientation menu 270, and a size menu 275. These enable the user to enter map preferences, such as whether a map book is generated (mapbook type menu 260), as well as scale, page orientation and size of the output map.

Finally, the data entry screen includes elements for custom data, to define buffer sizes, and enter revision numbers, author details and the like. This is particularly advantageous if the chosen mapping product is customisable according to parameters (e.g. buffer sizes), or if filtering is performed on the spatial data prior to generating the map.

The data entry screen is the only area which requires manual intervention from the user 110. For example, if the user wants an A3 size map of property 3/AB199 in landscape they select that they need a Property Plan (map product) of property 3/AB199 (reg plan) in A3 (size) landscape (orientation). The map is then automatically generated based thereon.

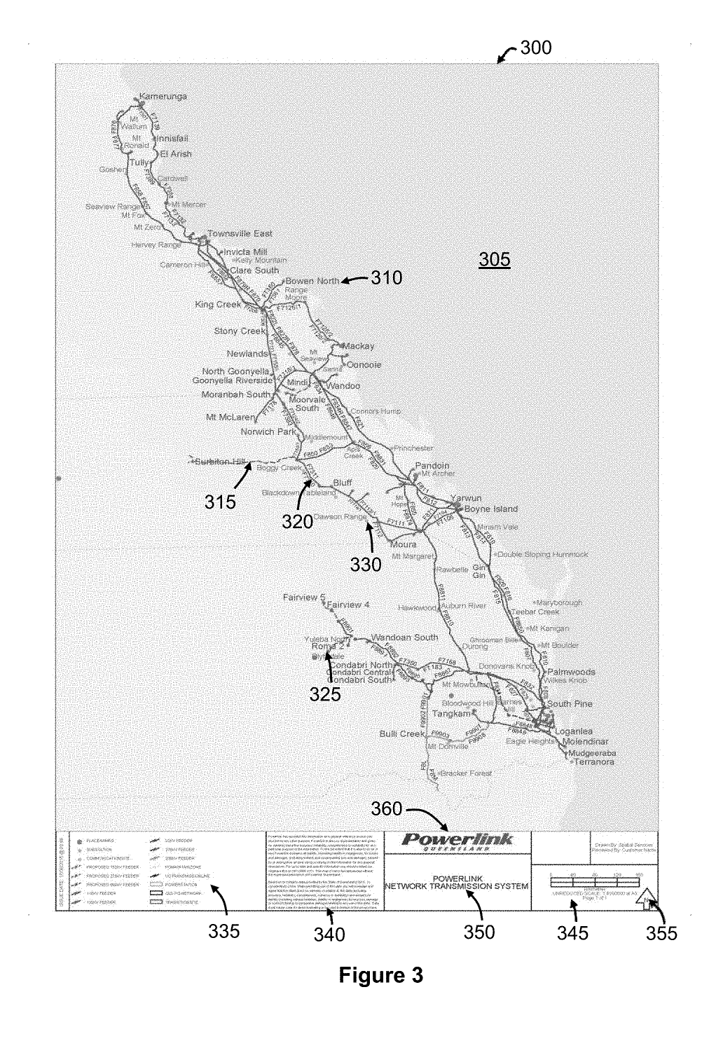

FIG. 3 illustrates a screenshot 300 of a first map output of the system 100, according to an embodiment of the present invention.

The map output includes a map portion 305, on which a plurality of elements are overlaid. The overlaid elements include place names 310, proposed feeder lines 315, existing feeder lines 320, substations 325 and communications sites 330.

The map output further includes marginalia in the form of a legend 335, a legal statement 340 (e.g. regarding liability and copyright), a scale 345, a map name 350, a north arrow 355 and a branding portion 360.

As discussed above, the system 100 enables maps to be generated in a consistent manner, and according mapping standards and policies. The abovementioned legal statement 340 and branding portion 360, for example, may be adapted to suit the particular standards and policies of a company.

The map output enables the user 110 to get a quick overview of the region, and in relation to relevant data, and without requiring any particular GIS skills in relation to that data. This enables those that are using the maps to create the maps directly.

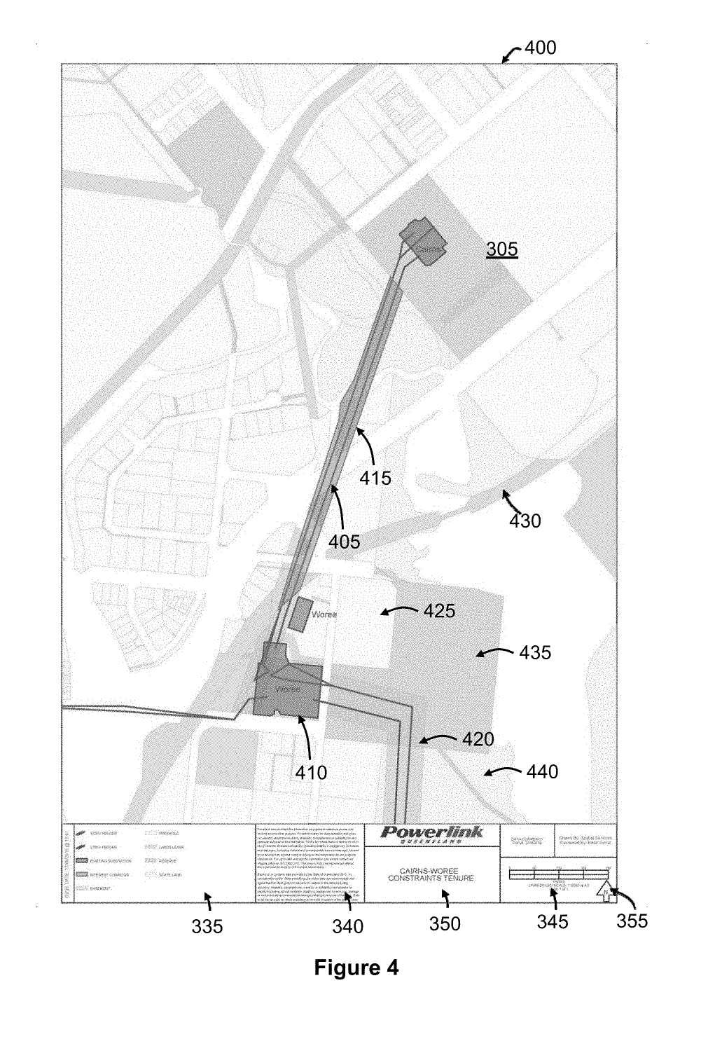

FIG. 4 illustrates a screenshot 400 of a second map output of the system 100, according to an embodiment of the present invention.

The map output includes a map portion 305, on which a plurality of elements are overlaid, and marginalia, similar to the first map output of FIG. 3. However, the overlaid elements include feeder lines 405, existing substations 410, and interest corridors 415, as well as land type identifiers such as easements 420, freehold land 425, lands lease 430, reserve 435 and state land 440.

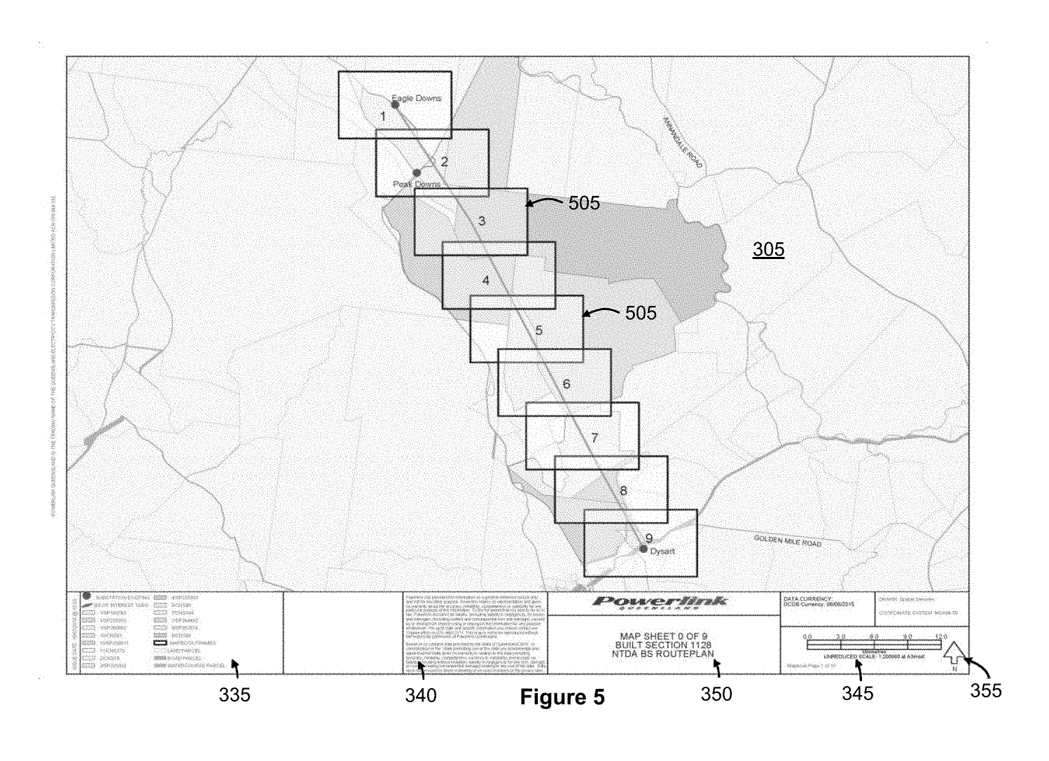

FIG. 5 illustrates a screenshot 500 of a third map output of the system 100, according to an embodiment of the present invention. The third map output relates to a map book rather than a single map.

The map output includes a map portion 305, on which a plurality of elements are overlaid, and marginalia, similar to the first map output of FIG. 3. However, the overlaid elements relate to a plurality of sub-maps, each overlapping along an area of interest.

In particular, the map includes a plurality of sub-map elements 505, each corresponding to a sub-map generated by the system. The sub-map elements 505 enable the user to quickly identify where each of the sub maps is located with respect to the area of interest. Each of the sub-maps may be similar to the first or second map outputs, described above, and illustrates a portion of the area of interest.

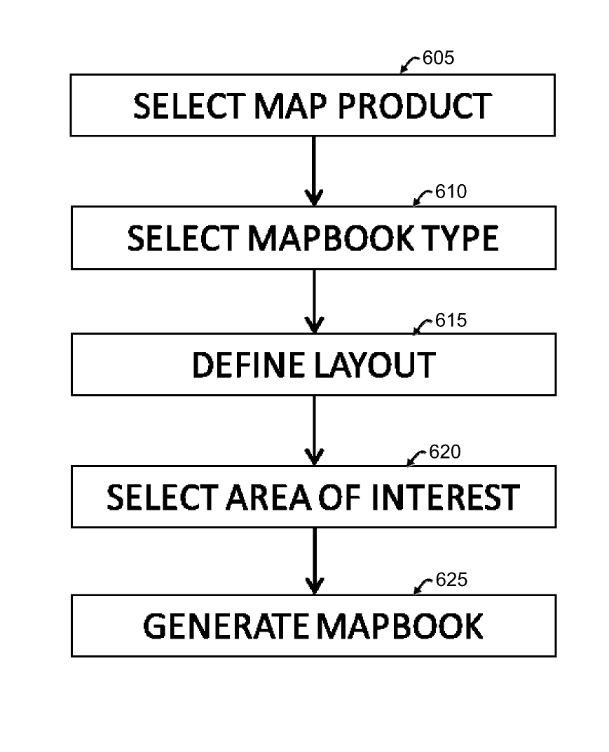

FIG. 6 illustrates a geospatial mapping method 600, according to an embodiment of the present invention. The method enables users to users to generate maps according to easy to understand selections by a user. The method 600 may, for example, be implemented by the system 100.

At step 605, a map product is selected by the user. An example of a map product is a “Property Plan”, and the map product defines the data to be incorporated into the map, and layout information, such as legal text, logos, and the like.

At step 610, a mapbook type is selected. This enables the user to select a single map to be generated (T1/2) or a mapbook comprising multiple sub maps (T3).

At step 615, a layout of the map is defined. For example, if the user requires an A3 landscape map, he or she may enter this in step 615.

At step 620, an area of interest is selected. The area of interest may comprise a region, a particular property, or the like. The property area of interest is then converted into a spatial geometry.

The area of interest selection may comprise a multi-step selection, wherein the user initially selects an area of interest type, and then enters details relating thereto. For example, the user may initially select that the area of interest is a Land Parcel, and then enter the Lot and Plan number defining the land parcel.

At step 625, the map (or mapbook) is generated based upon the user input from steps 605 to 620.

The map may be generated by creating a map frame of the region of interest, applying map layers according to the selected map product, and layout or style requirements.

According to certain embodiments, step 625 may include data analysis to enable data to be clipped, such that only show data inside the area of interest is displayed, rather than the entire map frame. This is particularly useful if the area of interest is a property, or similar area which does not substantially fill the map frame.

As an illustrative example, a map frame may be rectangular, whereas the area of interest may be a property. Due to the shape of the property, the map frame may be selected to comprise a rectangular area comprising the property, and a small buffer around the property. In such case, when data is overlaid onto the map frame, certain data may fill the entire map frame (i.e. be both inside and immediately outside of the selected area), while other data may be filtered so that only data inside the selected area is displayed.

According to certain embodiments, one layer may comprise the base map, on which other layers are overlaid thereon. In such case, the base map (i.e. the map on which data is overlaid) is different according to the selected map product. For example, a Property Plan map product may use high resolution satellite imagery, whereas other products may use simple map products).

The map is also labelled, as discussed above. According to certain embodiments, dynamic labelling can be used to ensure that labels from various layers do not overlap. This is particularly important in crowded maps. Similarly, a legend, scale bars and marginalia are added to the map at this stage.

The map may be output in any suitable format, including in portable document format (PDF). The map may be downloaded in response to the request to generate the map, or may be provided in an email when completed.

The skilled addressee will readily appreciate that steps 605-620 may be performed in any order. For example, the user may enter the area of interest (step 620) prior to selecting the map product (605).

The method enables users to produce many mapping products (e.g. from a catalogue of mapping products) based upon the same mapping data, without the need of specialised GIS expertise. In particular, a look up table (described above) may be used to select data and style the map on the fly. This facilitates the production of high quality, standardised maps which have the firm's required look and feel and satisfy the firm's requirements.

While the above has been described with reference to the user selecting an existing mapping product, the skilled addressee will readily appreciate that users can create their own mapping products. This enables maps that are generated often to be generated by the system in an efficient manner.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A geospatial mapping system
including: at least one data store,
including:
geospatial mapping data including a plurality of different types of data and relating to a plurality of geographical areas;
a plurality of map product definitions, each map product definition relating a map product to at least one type of geospatial mapping data of the geospatial mapping data; and
a mapping server, coupled to the at least one data store, configured
to: receive a selection of an area and a map product; and
generate a map according to the selected area and map product, and the map product definitions.

2. The system of claim 1, wherein the selection of the area and the map product is provided by a user, and the generated map is provided to the user in response thereto.

3. The system of claim 2, wherein the map is provided to the user by electronic mail.

4. The system of claim 1, wherein the selected map product is associated with more than one type of geospatial mapping data, and wherein each type of geospatial mapping data is used to generate a different layer of the map.

5. The system of claim 1, wherein the map is generated according to a style or layout associated with the selected map product.

6. The system of claim 1, wherein the mapping server is configured to receive one or more map preferences, and generate the map at least in part according to the map preferences.

7. The system of claim 6, wherein the map preferences are received from a user.

8. The system of claim 6, wherein the map preferences include a map size and a map orientation.

9. The system of claim 1, wherein the mapping server is configured to receive a request to generate a plurality of maps forming a map book.

10. The system of claim 9, wherein each map relates to part of the selected area, such that the plurality of maps together relate to the selected area.

11. The system of claim 9, wherein the map book includes an overview map, illustrating the relative position of each of the plurality of maps.

12. The system of claim 1, wherein the different mapping products include a first mapping product associated with a first type of mapping data, and a second mapping product associated with a second type of mapping data.

13. The system of claim 12, wherein the first and second mapping products relate to different layouts or styles.

14. The system of claim 12, wherein the first type of mapping data includes power transmission related data, and the second type of mapping data includes land ownership data and/or land rights data.

15. The system of claim 1, further including a look-up table, for associating map products with data types.

16. The system of claim 1, wherein the mapping server is configured to retrieve geospatial mapping data, from the data store, according to the selected area and the map product.

17. The system of claim 16, wherein the geospatial mapping data is received using one or more Procedural Language (PL) and/or Structured Query Language (SQL) queries.

18. The system of claim 16, wherein the system is configured to filter the retrieved data according to the selected area.

19. The system of claim 18, configured to filter one or more data types such that only data relating to the selected area is shown.

20. The system of claim 1, wherein the different types of data relate to different types of objects.

21. The system of claim 1, wherein the different types of data relate to different types of measurements or data estimates.

22. The system of claim 1, wherein the selected area may be defined by a lot, a region, a project, a site, a corridor, a plan, a feature, a maintenance region, and a feeder network.

23. A geospatial mapping method including:
receiving, from a user, a selection of an area and a map product; and
generating a map according to the selected area and map product, and a map product definition associated with the selected map product, wherein the map product definition relates the associated map product to at least one type of geospatial mapping data of a plurality of types of mapping data, and the map includes the mapping data.
